(19) United States
(12) Patent Application Publication
(10) Pub. No.: US 2019/0213558 A1
(43) Pub. Date: Jul. 11, 2019

(54) SMART REMINDER METHOD AND ELECTRONIC DEVICE

(71) Applicant: Chiun Mai Communication Systems, Inc., New Taipei (TW)

(72) Inventor: CHEN-SHENG HSU, New Taipei (TW)

(21) Appl. No.: 15/992,300

(22) Filed: May 30, 2018

(30) Foreign Application Priority Data
Jan. 9, 2018 (CN) 201810019369.5

(51) Int. Cl. G06Q 10/10

(52) U.S. Cl. CPC G06Q 10/1095

(57) ABSTRACT

A smart reminder method is executed by an electronic device. The smart reminder method includes steps of: setting at least one calendar event, each calendar event includes a valid time period and at least one attached condition; detecting whether a valid time period arrives; obtaining an effective calendar event according to the at least one attached condition of the at least one calendar event comprising the at least one valid time period that arrives; obtaining information related to the effective calendar event; and notifying a user of the obtained information. An electronic device is also provided.

### FIELD

The disclosure generally relates to communication technology, and particularly to a smart reminder method, system and electronic device.

### BACKGROUND

Calendar functions can make it easy for users to manage their own calendar by allowing them to edit or set multiple calendar events and corresponding reminder times. However, most electronic devices prompt calendar events when a prompting time arrives. In some specific cases, the user needs to leave before a prompting time of the calendar event for special reasons, then the user is out when the prompt is received from the electronic device, and the user is not reminded about the calendar event in time.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a functional block diagram of an embodiment of an electronic device.

FIG. 2 is a functional block diagram of an embodiment of a smart reminder system.

FIG. 3 is a flow diagram of an embodiment of a smart reminder method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

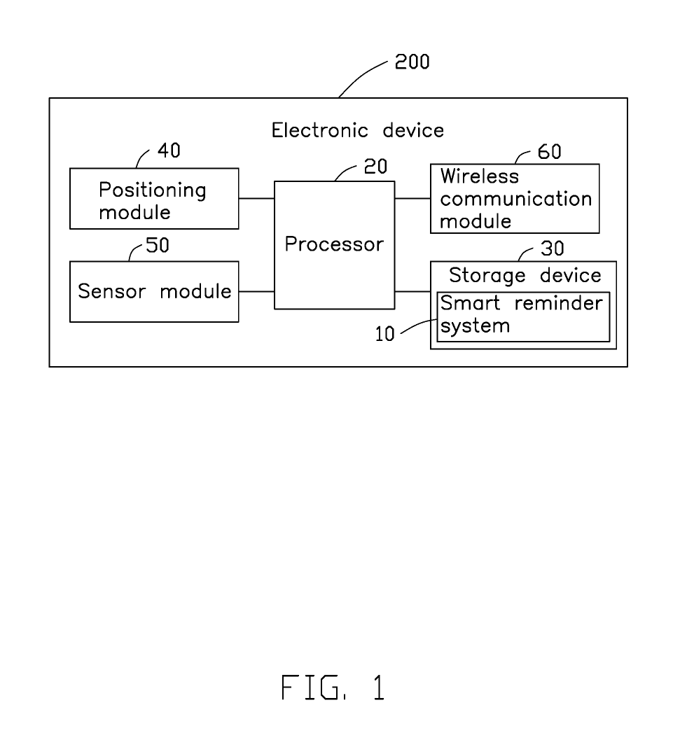

FIG. 1 shows an electronic device 200 in accordance with an embodiment. The electronic device 1 includes a smart reminder system 10, a processor 20, a storage device 30, a positioning module 40, a sensor module 50 and a wireless communication module 60. The electronic device 200 can be a portable electronic device such as a tablet computer, a mobile phone, a PDA (personal digital assistant) and other portable devices.

The processor 20 can be a central processing unit (CPU), a microprocessor, or other data processor chip.

The storage device 30 is embedded in the electronic device 200. In an alternative embodiment, the storage device 30 can also be a separate external memory card, for example, an SM card (Smart Media Card), an SD card (Secure Digital Card), or the like.

The positioning module 40 can be a Global Positioning System (GPS) or a BEIDOU module. The positioning module 40 is configured for obtaining the location information of the electronic device 200. The sensor module 50 can be an ultraviolet sensor module. The sensor module 50 is configured for detecting ultraviolet intensity. The wireless communication module 60 can be a BLUETOOTH module, a WIFI module, or the like. The wireless communication module 60 is configured for sending wireless signals.

The smart reminder system 10 is installed and operated in the electronic device 200. The storage device 30 is configured for storing the smart reminder system 10 and related data, for example, a calendar event. The processor 20 is configured for executing the operating system and the applications of the electronic device 200, for example, the smart reminder system 10.

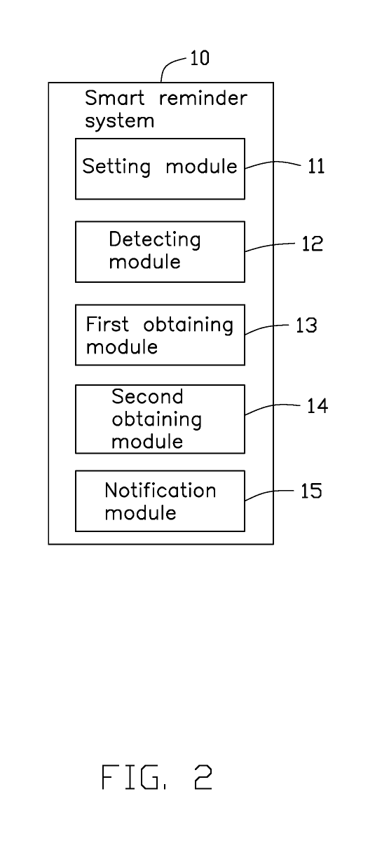

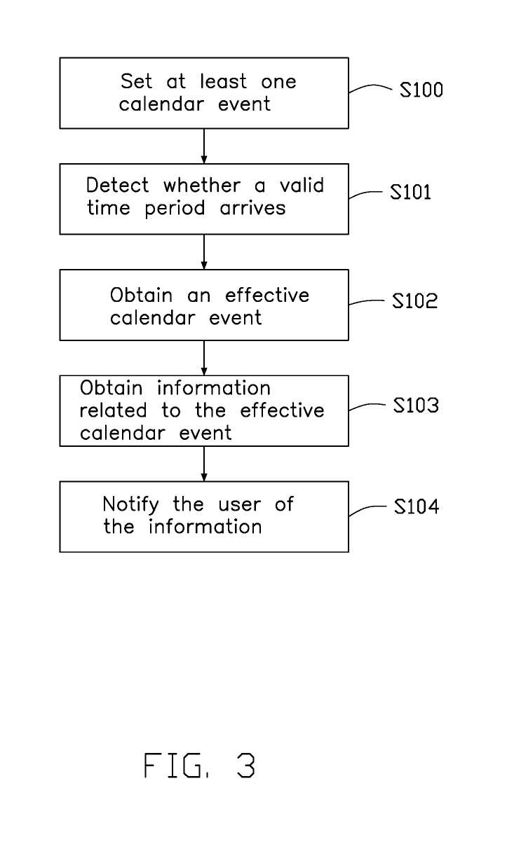

Referring to FIG. 2, the smart reminder system 10 includes a setting module 11, a detecting module 12, a first obtaining module 13, a second obtaining module 14, and a notification module 15. FIG. 3 illustrates a flowchart of a method which is presented in accordance with an example embodiment. Additionally, the illustrated order of blocks is by example only and the order of the blocks can be changed. Depending on the embodiment, additional steps can be added, others removed, and the ordering of the steps can be changed.

At block 100, the setting module 11 sets at least one calendar event. Each calendar event comprises a valid time period and at least one attached condition.

A user can set one or more calendar events, and can set the valid time period, the attached condition, and an information subject for each calendar event by the setting module 11. In one embodiment, the setting module 11 is an application with a calendar event management function installed in the electronic device 200, for example, the application with function for managing time, calendar, and event. The user can open the application with a calendar event management function to set one or more calendar event, the attached condition and the information subject.

For example, the valid time period of one calendar event are 7:00 am to 8:00 am on a certain day or a few days.

For example, the wireless communication module 60 can pair the electronic device 200 with another preset electronic device. One attached condition of one calendar event can be whether a pairing connection is established between the electronic device 200 and another preset electronic device, that is, whether the electronic device 200 being successfully connected with another preset electronic device. The other preset electronic device can be a car computer of the user of the electronic device 200, or a wireless AP in the user's home. When the electronic device 200 is successfully connected with another preset electronic device, then the attached condition is satisfied.

For example, the electronic device 200 can obtain real-time location information of itself by a positioning module 40. The attached condition can be whether the electronic device 200 arrives at a preset position, that is, whether a current position of the electronic device 200 arriving at a preset position. When the electronic device 200 has arrived at a preset position, then the attached condition is satisfied.

For example, the electronic device 200 can detect ambient ultraviolet intensity by a sensor module 50. The attached condition can be whether the ambient ultraviolet intensity is higher than a preset value. When the ambient ultraviolet intensity is higher than a preset value, then the attached condition is satisfied.

At block 101, the detecting module 12 detects whether a valid time period arrives. The detecting module 12 can detect at a predetermined frequency whether the valid time period is arrived. That is, the detecting module 12 can start periodically to detect whether the valid time period arrives.

For example, the user can set the valid time period of the calendar event as 7:00 am to 8:00 am on weekdays. If the current time is between 7:00 am to 8:00 am on a weekday, then the detecting module 12 can determine that the current time is in the valid time period, that is, the valid time period has already arrived, otherwise the detecting module 12 determines that the valid time period does not arrive yet. The detecting module 12 can detect whether the valid time period arrives after the specific time. When the valid time periods of multiple calendar events overlap completely or partially, the current time can be detected as being within multiple valid time periods, that is, multiple valid time periods can arrive simultaneously.

At block 102, the first obtaining module 13 obtains an effective calendar event. If a calendar event includes a valid time period that arrives and each attached condition of the calendar event is satisfied when the valid time period arrives, the calendar event is an effective calendar event. The first obtaining module 13 searches for calendar events including valid time periods that arrive according to the valid time periods of the calendar events. The first obtaining module 13 determines whether each attached condition of the calendar event is satisfied to obtain the effective calendar event.

At block 103, the second obtaining module 14 obtains information related to the effective calendar event.

Each calendar event includes at least one information subject. Each information subject corresponds to related information content, the information and the information subject of different calendar events can be same or different. For example, the information subject can be weather information, vehicle information, traffic information, route information, or financial information. The information related to the weather information can be weather information for the day, ultraviolet intensity, temperature, air humidity, air quality, wind direction and other information. The information related to the vehicle information can be tire pressure, oil quantity and pressure, and other information. The information related to the route can be the current position of the electronic device 200, a destination, and navigation route between the current position and destination. The traffic information can be quantity of other vehicles along a route, and other information. The information related to the financial information can be stock market, foreign exchange, futures market, financial data and other information. The information related to the effective calendar event includes all information associated with each information subject of the effective calendar event.

The second obtaining module 14 obtains information related to the effective calendar event from the electronic device 200 when the information is locally stored in the electronic device 200. The second obtaining module 14 may obtain information from an external network when the information is not locally stored in the electronic device 200. The locally stored information can be various kinds of information, materials, and/or files preset or stored in the electronic device 200 by the user.

In another embodiment, the second obtaining module 14 obtains information related to the effective calendar from another electronic device communicatively connected to the electronic device. For example, the information related to the vehicle information can include the temperature, humidity, wind direction, tire pressure, navigation route, and other information. The second obtaining module 14 obtains the temperature, the air humidity, the wind direction and the navigation route from the Internet, and obtains the tire pressure from the another electronic device, such as the computer of a car.

At block 104, the notification module 15 notifies the user of the information. The notification module 15 can display the information to the user by displaying a text box or notify the user by voice. The contents of the display text box can be the information.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A smart reminder method executed by an electronic device, the smart reminder method comprising:
setting at least one calendar event, each calendar event comprising a valid time period and at least one attached condition;
detecting whether a valid time period arrives;
obtaining an effective calendar event according to the at least one attached condition of the at least one calendar event comprising the at least one valid time period that arrives;
obtaining information related to the effective calendar event; and
notifying a user of the obtained information.

2. The smart reminder method of claim 1, wherein the effective calendar event comprises the valid time period that arrives and each attached condition of the effective calendar event is satisfied when the valid time period arrives.

3. The smart reminder method of claim 1, wherein an attached condition of a calendar event is whether a pairing connection is established between the electronic device and another preset electronic device, whether the electronic device arrives at a preset position, or whether an ambient ultraviolet intensity is higher than a preset value.

4. The smart reminder method of claim 1, wherein each calendar event comprises at least one information subject, each information subject is associated with at least one information, the information related to the effective calendar event comprises all information associated with each information subject of the effective calendar event.

5. The smart reminder method of claim 1, wherein the information related to the effective calendar event is obtained from the electronic device, an external network, and/or another electronic device communicatively connected to the electronic device.

6. An electronic device, comprising:
a processor; and
a storage device communicatively coupled to the processor, the storage device storing computer-executable instructions that when executed by the processor, cause the at least one processor to:
set at least one calendar event, each calendar event comprising a valid time period and at least one attached condition;
detect whether a valid time period arrives;
obtain an effective calendar event according to the at least one attached condition of the at least one calendar event comprising the at least one valid time period that arrives;
obtain information related to the effective calendar event; and
notify a user of the obtained information.

7. The electronic device of claim 6, wherein the effective calendar event comprises the valid time period that arrives and each attached condition of the effective calendar event is satisfied when the valid time period arrives.

8. The electronic device of claim 6, wherein an attached condition of a calendar event is whether a pairing connection is established between the electronic device and another preset electronic device, whether the electronic device arrives at a preset position, or whether an ambient ultraviolet intensity is higher than a preset value.

9. The electronic device of claim 6, wherein each calendar event comprises at least one information subject, each information subject is associated with at least one information, the information related to the effective calendar event comprises all information associated with each information subject of the effective calendar event.

10. The electronic device of claim 6, wherein the information related to the effective calendar event is obtained from the electronic device, an external network, and/or another electronic device communicatively connected to the electronic device.

11. A non-transitory computer-readable medium storing a set of instructions that, when executed by at least one processer, cause the at least one processor to:
set at least one calendar event, each calendar event comprising a valid time period and at least one attached condition;
detect whether a valid time period arrives;
obtain an effective calendar event according to the at least one attached condition of the at least one calendar event comprising the at least one valid time period that arrives;
obtain information related to the effective calendar event; and
notify a user of the obtained information.

12. The non-transitory computer-readable medium of claim 11, wherein the effective calendar event comprises the valid time period that arrives and each attached condition of the effective calendar event is satisfied when the valid time period arrives.

13. The non-transitory computer-readable medium of claim 11, wherein an attached condition of a calendar event is whether a pairing connection is established between the electronic device and another preset electronic device, whether the electronic device arrives at a preset position, or whether an ambient ultraviolet intensity is higher than a preset value.

14. The non-transitory computer-readable medium of claim 11, wherein each calendar event comprises at least one information subject, each information subject is associated with at least one information, the information related to the effective calendar event comprises all information associated with each information subject of the effective calendar event.

15. The non-transitory computer-readable medium of claim 11, wherein the information related to the effective calendar event is obtained from the electronic device, an external network, and/or another electronic device communicatively connected to the electronic device.
